(19) United States
(12) Patent Application Publication
(10) Pub. No.: US 2018/0098616 A1
(43) Pub. Date: Apr. 12, 2018

(54) Wearable Electronic Media Support and Storage System

(71) Applicant: Emanuela Iannotta, Paterson, NJ (US)

(72) Inventor: Emanuela Iannotta, Paterson, NJ (US)

(21) Appl. No.: 15/727,408

(22) Filed: Oct. 6, 2017

Related U.S. Application Data
(60) Provisional application No. 62/405,024, filed on Oct. 6, 2016.

(51) Int. Cl. A45F 3/14; A45F 3/08; A45F 3/04; A45F 5/02; G06F 1/16

(52) U.S. Cl. CPC A45F 3/14; A45F 3/08; A45F 3/047; A45F 2003/045; G06F 1/1628; A45F 2003/146; A45F 5/02

(57) ABSTRACT

An adjustable, wearable support and storage system for suspending electronic media, particularly tablet computers, eReaders, and smartphones, in a hands free manner outward from the body in virtually any position.

### CLAIM OF PRIORITY

This patent application claims priority under 35 USC 119(e)(1) from U.S. Provisional Patent Application Ser. No. 62/405,024 filed Oct. 6, 2016, of Emanuela Ianotta entitled, “No More Strain” which is incorporated herein by reference as though the same were set forth in its entirety

### FIELD OF THE INVENTION

The present invention pertains to the field of electronic media accessories, and more specifically to the field of support and storage accessories.

### BACKGROUND OF THE INVENTION

The prior art has put forth several designs for support and storage accessories for electronic media. Among these are:

U.S. Pat. No. 8,844,448 to Lester Samuel Allen and Lester Celestino Allen describes a device relating generally to a portable support plane, and more particularly to a neck harness sling that goes on a user's neck and suspends a rectangular reversible plane that provides a hands free, stable surface that supports portable electronic devices including but not limited to tablets and smartphones, or legal pads about a user's neck for convenient writing, typing or texting while walking, sitting, standing or reclining.

U.S. Pat. No. 8,109,421 to John Elliott McLean and John Elliott McLean, Jr. describes a hands free case for mobile personal computers that provides a mobile worker with a stable platform for laptops, tablet PCs, ultra mobile PCs and accessories. One embodiment comprises a platform insert, fabric shell, shoulder harness, waist torso harness and an articulated flap. The shoulder harness and waist torso harness is attached to a fabric shell by means of two or more rings and hooks allowing multiple configurations of straps and computer display orientations. A mobile personal computer is secured to the platform insert by impact resistant cordage. When the shoulder harness and waist torso harness is placed around the body, a mobile person& computer is carried without being held. The case is positionable vertically along the body and tilted to improve viewing by adjusting the length of the shoulder harness and the waist torso harness. When the articulated flap is buckled to top of fabric shell, the mobile personal computer is enclosed in a protective case.

US Patent Publication 2012/0068044 to Louis Angel Rivera describes a hands free media platform apparatus. The media platform includes a collar, a pair or arms projecting from the collar, and a platform coupled to the arms. The platform is adapted to hold media so the media is viewable by a user wearing the apparatus without the media being handheld. The apparatus includes adjustable elements providing customized viewing angles of media carried on the platform.

None of these prior art references describe the present invention.

### SUMMARY OF THE INVENTION

It is an object of the present invention to provide an adjustable, wearable support and storage system for suspending electronic media, particularly tablet computers, eReaders, and smartphones, in a hands free manner outward from the body in virtually any position.

### BRIEF DESCRIPTION OF THE DRAWINGS

FIG. 1 is a perspective, back to side view of the present invention showing its harness and waist straps, extendable holding rod and distal connecting clip for securely clasping an electronic device.

FIG. 2 is a close up diagonal view showing the waist strap and a connected pouch for storing an electronic device.

FIG. 3 is a close up front view showing the harness straps, waist straps and a connected pouch for storing an electronic device.

FIG. 4 is a perspective front to side view of the present invention showing its harness and waist straps, extendable holding rod and distal connecting clip for securely clasping an electronic device.

FIG. 5 is a functional front diagonal view of the present invention being worn by a female figure who is viewing a tablet clipped to holding rod.

FIG. 6 is a functional front diagonal view of the present invention in a compacted and resting position around the shoulders, back and waist of a female figure.

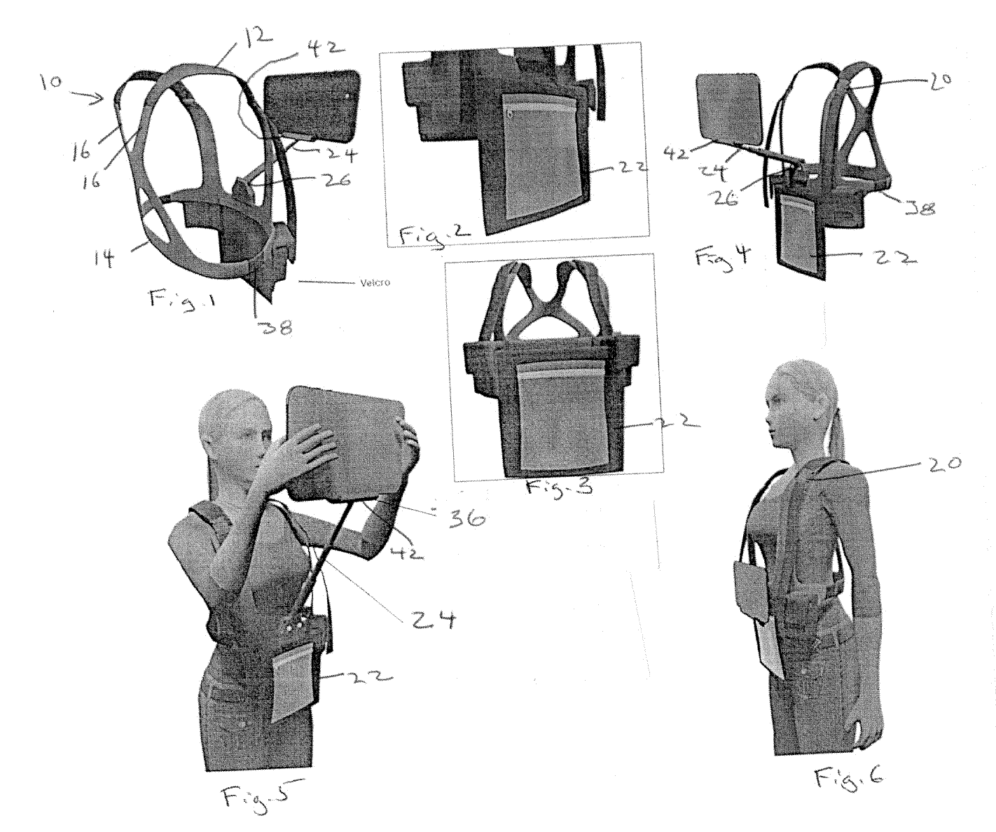

### DETAILED DESCRIPTION OF THE INVENTION

Dependence on computer technology has reached unprecedented levels as corporations and governments rely on computer technology to keep track of global business operations, financial supplies and national securities. The prevalence of computers in the workplace has reached a point that most firms require applicants to have at least some computer experience. A large majority of the national workforce now uses a computer at their jobs and rely on the Internet in their daily routine. Computer technology has evolved to encompass wireless communication with ubiquitous mobile devices such as digital music players, electronic readers, and sleek portable tablet computers such as Apple's iPad, providing access to the world at one's fingertips.

A primary disadvantage of the iPad and similar tablet computers is they must be held in a user's hands for operation. The user uses one hand to secure the device and the other hand to press the touchscreen commands. Such a process quickly becomes exhausting. Because a tablet is placed flat on a surface to help with two handed usage, owners often uncomfortably contort their bodies to see and access the screen.

Please refer to the drawings. The present invention is a wearable electronic media support and storage system, also referred to as No More Strain is an adjustable, wearable support and accessory storage system for suspending electronic media, particularly tablet computers, eReaders, and smartphones, in a hands free manner, outward from one's body in virtually any position. No More Strain is a versatile accessory that functionally optimizes hands free usage of these electronic devices in a strain free and pain free manner, especially regarding one's neck and back. Using No More Strain ergonomically alleviates stress, strain and inconvenience of bending one's neck and head to view a device held lower than eye level. Using No More Strain alleviates strain associated with constantly holding a device,

No More Strain is presented in the form of a harness device 10 that is worn around the torso of the user. The harness portion 12 of this system is a combination of belts and straps engineered to fit over an user's shoulders, down their back, over their chest and stomach area, and around their waist. Harness 12 is comprised of waist strap 14 which encircles the user's waist. Perpendicular to waist strap 14 are two criss-cross shoulder straps 16 that criss-cross from the waist strap 14 up over the users shoulders and down the front of the user. Each shoulder strap 16 is adjustable by means of adjusting clip 20. The belts are also easily adjustable by means of hook and loop fasteners for a customized fit around the individual's waist and shoulders. The harness 12 and waist strap 14 components of No More Strain are produced in various sizes including Small, Medium, Large, and Extra Large.

The front section of the harness 12 is augmented with a secure, pouch component 22 that is able to store a tablet or pad when not in use and also. Pouch 22 hangs from waist trap 14 at the upper edge of the pouch 22. Holding rod 24 is capable of telescoping out and suspends the tablet outward from a holding rod 24, close to eye level or wherever positioned. The holding rod 24 is telescopic and pivot mounted, allowing it to extend and retract, and move from side to side, up and down, and all around, permitting easy access to the screen from virtually any angle. The rod 24 can be made of any suitable material such as titanium, or aluminum, for example. Rod 24 is attached to the waist strap 14 by means of a ball joint 26 to allow pivotal motion for positioning the device. When in use, the tablet is suspended upward in the user's front viewing scope, enabling the user to operate the electronic device without having to hold it in their hands continuously. The harness 12 can be put on over the wearer's head and buckled on the side by side buckle 38.

A universal connecting clip 42, which secures an electronic device to the distal end of the holding rod 24, accommodates any smartphone or tablet. The clip can rotate 360 degrees. The connecting clip holds standard smartphones and tablets weighing up to approximately five pounds. For large heavier tablets weighing approximately five to ten pounds, clip 42 can be constructed that is wider in width and has a higher backing for stability in supporting these heavier devices. When a user is not operating and viewing an attached tablet, device 10 is folded or closed to their waist, keeping it handily convenient yet out of the way.

The pouch 22 of No More Strain is effectively functions as a clever and convenient handbag for storing and transporting a variety of personal items. A number of zippered pouches and pockets are manufactured for storing various other electronic devices and accessories, such as a smartphone, charger, earphones and writing utensils. No More Strain is produced in a variety of colors and patterns to appeal to individual tastes.

Conceived as a highly versatile, portable docking station for electronic media such as tablet computers, e-readers and smart phones, No More Strain functionally provides an effortless, convenient means for a person to use their electronic devices in a virtually hands free manner and to securely store them. No More Strain is constructed with durable, adjustable hardware that fits securely to a person. Durably constructed of high quality materials and components, No More Strain withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An adjustable, wearable support and accessory storage system for suspending electronic media, particularly tablet computers, eReaders and smartphones, in a hands free manner outward from the body in virtually any position, comprising a harness device that is worn around the torso of the user, comprising: a waist strap, criss-crossed should straps perpendicularly attached to the waist strap and which should straps extend over the shoulders of a user, further comprising a pouch component attached to the waist strap that is able to store a tablet or pad when not in use and also, wherein the pouch component hangs from waist trap at the upper edge of the pouch 22, further comprising a holding rod, wherein the holding rod is capable of telescoping out and suspending a tablet outward from the user,

2. The adjustable, wearable support and accessory storage system for suspending electronic media of claim 1, further wherein the holding rod is attached to the waist strap by means of a pivot joint allowing it to extend and retract, and move from side to side, up and down, and all around, permitting easy access to the screen from virtually any angle.

3. The adjustable, wearable support and accessory storage system for suspending electronic media of claim 2, wherein the rod is made of titanium, or aluminum.

4. The adjustable, wearable support and accessory storage system for suspending electronic media of claim 2, further comprising a clip on the waist strap.

6. The adjustable, wearable support and accessory storage system for suspending electronic media of claim 1, wherein pouch functions as a handbag for storing and transporting a variety of personal items.

7. The adjustable, wearable support and accessory storage system for suspending electronic media of claim 2 produced in a variety of colors and sizes.

8. The adjustable, wearable support and accessory storage system for suspending electronic media of claim 2, wherein the shoulder strap is adjustable by means of adjusting clip

9. The adjustable, wearable support and accessory storage system for suspending electronic media of claim 2 wherein t waist trap is adjustable by means of hook and loop fasteners for a customized fit around the individual's waist and shoulders.
